(19) United States
(12) Patent Application Publication
(10) Pub. No.: US 2025/0153203 A1
(43) Pub. Date: May 15, 2025

(54) PIEZO ACTUATOR DEVICE, PREFERABLY WITH TRANSVERSELY DEFLECTABLE NOZZLE

(71) Applicant: Dürr Systems AG, Bietigheim-Bissingen (DE)

(72) Inventor: Christoph Renz, Kirchberg an der Murr (DE)

(21) Appl. No.: 18/837,934

(22) PCT Filed: Feb. 1, 2023
(86) PCT No.: PCT/EP2023/052383

§ 371 Date: Aug. 13, 2024

(30) Foreign Application Priority Data
Feb. 14, 2022 (DE) 10 2022 103 375.9

(51) Int. Cl. B05B 1/34

(52) U.S. Cl. CPC B05B 1/341

(57) ABSTRACT

The disclosure relates to a piezo actuator device, preferably for attachment to a manipulator and/or for enabling a swirl application on a component, comprising a nozzle for dispensing an application agent onto a component, a rod, that comprises the nozzle and preferably is hollow and/or configured as a tube, and at least two piezo actuator apparatuses which are configured to deflect the rod in different directions transversely to its longitudinal axis, whereby preferably the nozzle can be moved along at least one movement path. The disclosure also relates to an associated application device and an associated method.

### CROSS-REFERENCE TO RELATED APPLICATIONS

This application is a national stage of, and claims priority to, Patent Cooperation Treaty Application No. PCT/EP2023/052383, filed on Feb. 1, 2023, which application claims priority to German Application No. DE 10 2022 103 375.9, filed on Feb. 14, 2022, which applications are hereby incorporated herein by reference in their entireties.

### FIELD

The disclosure relates to a piezo actuator device, preferably with a transversely deflectable nozzle for dispensing an application agent, e.g. for enabling a swirl application on a component.

### BACKGROUND

In particular in the area of vehicle sealing and vehicle preservation with PVC plastisols or the application of adhesives, techniques such as flat stream, airless, round jet or related applications are known to date. The use of a so-called swirl for a swirl application represents here a special application technique of round jet seams. DE 10 2014 015 057 A1, e. g., already discloses a device for creating a conventional swirl application.

Usually, to create a swirl application on a component, a nozzle is deflected using an electric motor by means of an eccentric on a circular path around a system central axis (e.g. axis of rotation) in order to apply the round jet seam in wider, overlapping circles. Compared to a conventional dispensing device (e.g. volume flow, nozzle diameter, robot speed, etc.), the parameters for such a round jet seam are therefore extended by the rotational speed and the deflection of the eccentric.

However, deflection of the nozzle by means of an electric motor with an eccentric means that, e.g., edge accumulations are indispensable for the seam produced, as the application agent jet is deposited on the application surface in a sine wave when the applicator is moved along the component, e.g. by means of a robot. In order to compensate for this disadvantage, the dwell time of the nozzle at the seam edge and in the center of the seam would have to be the same in order to apply the same amount of application agent. This is possible, e.g., with an elliptical circular path, but this requires the applicator to be reoriented.

If the deflection of the eccentric needs to be changed during application, e.g. to adjust the seam, an active eccentric adjustment is necessary, which, based on the same concept (in particular driven by an electric motor), is complex and prone to errors.

### BRIEF DESCRIPTION OF THE DRAWINGS

FIG. 1 shows a side view of a piezo actuator device according to an embodiment of the disclosure,

FIG. 2 shows a front view of the piezo actuator device,

FIG. 3 shows a top view of the piezo actuator device,

FIG. 4 shows a sectional view of the piezo actuator device,

FIG. 5 shows the sectional view of FIG. 4, in particular to illustrate a functional/actuation principle according to an embodiment of the disclosure,

FIG. 6 schematically illustrates a functional/actuation principle according to an embodiment of the disclosure,

FIGS. 7 and 8 illustrate different nozzle movement paths according to an embodiment of the disclosure,

FIG. 9 shows an application device according to an embodiment of the disclosure and

FIG. 10 shows a control scheme for a piezo actuator device according to an embodiment of the disclosure.

### DETAILED DESCRIPTION

An object of the disclosure is to provide an alternative and/or improved device for applying an application agent to a component (e.g. motor vehicle body component), in particular for enabling a swirl application on the component.

The disclosure relates to a piezo actuator device, e.g. for attachment to a manipulator (e.g. robot) and/or for enabling a swirl application, in particular on a component such as, e.g., a motor vehicle body component.

The piezo actuator device comprises a nozzle, in particular with a dispensing opening, for dispensing an application agent onto a component (e.g. a motor vehicle body component).

The application agent can be, e.g., a viscous, in particular highly viscous application agent.

The application agent can include, e.g., a sealant, a polyvinyl chloride (PVC, in particular a PVC plastisol), a thickener, a paint, an adhesive, a preservative agent (e.g. wax) and/or an insulating material.

The piezo actuator device also comprises a rod (e.g. hollow and/or configured as a tube), that comprises the nozzle, and at least two piezo actuator apparatuses.

The piezo actuator apparatuses are in particular configured to deflect, preferably to variably deflect, the rod (in particular during a dispensing of the application agent) in different directions transversely (e.g. laterally, crosswise, obliquely and/or substantially orthogonally) to the longitudinal axis of the rod.

This makes it possible, e.g., that the nozzle is preferably movable along at least one movement path (e.g. around a system central axis). The at least one movement path can, e.g., include at least one substantially circular movement path, at least one substantially elliptical movement path and/or at least one movement path that deviates from a circular movement path. Alternatively or additionally, e.g., at least one zigzag-shaped movement path and/or at least one polygon-shaped movement path is even possible.

The piezo actuator device is preferably suitable for the application of one or multiple patterns that can be defined in particular by means of the piezo actuator apparatuses (e.g. with a highly viscous application agent).

It is thus preferably possible that, by the deflection of the nozzle by means of the piezo actuator apparatuses, also one or more movement paths other than just circular paths can be generated for the nozzle, e.g. in order to be able to advantageously influence an application agent distribution in the cross-section of an application agent seam.

Preferably, the at least one movement path can extend (e.g. eccentrically) around a system central axis of the piezo actuator device.

The at least one movement path preferably forms a (e.g. open or closed) movement path and/or circulating path expediently around the system central axis.

It can be particularly preferable that the nozzle is movable by means of the piezo actuator apparatuses, e.g., along different movement paths (e.g. around the system central axis).

Alternatively or additionally, it can be particularly preferable that, by means of the piezo actuator apparatuses, e.g., an application agent distribution in the cross-section of an application agent seam can be advantageously influenced (e.g. changed). This enables, e.g., that a substantially uniform application agent distribution in the cross-section of an application agent seam can be achieved and/or an application agent edge accumulation in the cross-section of an application agent seam can be reduced, preferably substantially avoided.

By means of the advantageously variable deflection of the rod and thus of the nozzle by the use of the piezo actuator apparatuses, different movement paths can preferably be generated for the nozzle.

Due to the deflection of the nozzle by means of the piezo actuator apparatuses, usually complex mechanical constructions for changing an “eccentric” can be advantageously omitted.

The different movement paths can, e.g., be geometrically different (e.g. circular and elliptical) and/or geometrically the same, but of different sizes (e.g. circular of different sizes).

It should be mentioned that the piezo actuator device is, preferably during the dispensing of the application agent onto the component, moved along the component by means of the manipulator in order to create an application (e.g. an application agent seam, a coating, etc.) on the component. However, embodiments in which the piezo actuator device is mounted stationary are also possible.

The piezo actuator device can, e.g., comprise a bearing device (e.g. a wobble bearing) for supporting the rod.

The bearing device can, e.g., be configured to support the rod in a wobbleable manner and/or to support the rod transversely movable relative to its longitudinal axis. Alternatively or additionally, the bearing device can, e.g., be supported (expediently axially and/or radially) by means of at least one elastic bearing element, preferably by means of at least one in particular elastic O-ring.

In the context of the disclosure, it is possible that the bearing device provides a (e.g. axial and/or radial) degree of freedom of movement for the rod and the degree of freedom of movement is less than 5 mm, 2 mm, 1 mm or 0.5 mm.

The system central axis can, e.g., extend axially through the bearing device and/or be defined, e.g., by a center axis of the bearing device.

It is possible that the rod is drivable in a bearing area by means of the piezo actuator apparatuses, preferably drivable transversely relative to its longitudinal axis. The bearing area can thus preferably form a drive point for transversal deflection of the rod.

The bearing area can, e.g., be positioned between the bearing device and the nozzle.

It is possible that a longitudinal extend of the rod from the bearing area to the outlet of the nozzle is greater than or equal to a longitudinal extend of the rod from the bearing area to the bearing device.

The longitudinal extend of the rod from the bearing area to the outlet of the nozzle can be greater than the longitudinal extend of the rod from the bearing area to the bearing device, e.g., by a factor of at least 1.1, at least 1.2, at least 1.5, at least 1.8 or at least 2.

A deflection of the nozzle can preferably be greater than a deflection of the rod in the bearing area B2, wherein, e.g., a deflection of the rod at the bearing device can be smaller than the deflection in the bearing area B2. (e.g.: L2>L1 and/or h2>h1>h0).

The piezo actuator apparatuses can, e.g., be configured to actuate the rod with a, preferably variable, actuation frequency between, for example, 0 Hz to at least 300 Hz, to at least 350 Hz, to at least 400 Hz, to at least 450 Hz, to at least 550 Hz, to at least 650 Hz or to at least 700 Hz.

The piezo actuator apparatuses can, e.g., also be configured to move the nozzle by means of the rod on at least one movement path, preferably a circular path, which corresponds to a rotational speed of, for example, at least 10,000, at least 15,000 or at least 20,000 revolutions per minute.

The rod can, e.g., be hollow, configured as a tube and/or in particular comprise, e.g., a central application agent channel to guide the application agent to the nozzle.

In the context of the disclosure, the rod can thus be configured, e.g., as a tube (e.g. nozzle tube) and/or as an elongated hollow body.

The application agent channel can, e.g., extend at least partially or completely substantially coaxially or parallel to the longitudinal axis of the rod.

The application agent channel can, e.g., extend through the bearing device and/or through the bearing area and/or comprise an axial inlet opening for the application agent.

The application agent channel can, e.g., extend up to the nozzle and/or up to the outlet of the nozzle.

It is possible that the piezo actuator device comprises an applicator.

The bearing device can, e.g., be positioned in the applicator.

The bearing area can, e.g., be positioned outside the applicator.

The application agent can preferably be guided through the applicator into the rod and/or the nozzle.

It is possible that piezo actuator device comprises an application agent valve for activating and deactivating the dispensing of the application agent. The application agent valve, in particular its valve seat, can, e.g., be positioned upstream of the rod and/or outside the rod. The application agent valve is preferably a needle valve and can thus in particular comprise a valve needle. The application agent valve and/or a valve seat for the valve needle is positioned, e.g., in the applicator, preferably upstream of the rod.

The piezo actuator device can comprise, e.g., an application agent valve, that comprises a valve needle, for activating and deactivating the dispensing of the application agent, wherein preferably the valve needle can extend expediently at least partially axially in the nozzle and/or in the rod and can, e.g., be flowable around by application agent. The valve needle can preferably be configured flexible (e.g. elastic), extend through the bearing device and/or through the bearing area. A valve seat for the valve rod is preferably positioned in the rod, in the nozzle and/or expediently just before the nozzle, e.g. in the outlet-side quarter, fifth or sixth of the rod. This can advantageously reduce or avoid dripping of the application agent. The valve needle can, e.g., be guided at at least one or at least two guide points within the rod.

It is possible that the piezo actuator apparatuses each comprise a piezo actuator.

The piezo actuator apparatuses can, e.g., each comprise an actuating arm structure for actuating the rod, wherein the actuating arm structures can preferably be actuated (e.g. driven) by the respective piezo actuator.

The respective actuating arm structure can, e.g., be part of an at least three-joint or at least four-joint lever mechanism.

It is possible that the respective actuating arm structure is pivotable about a base joint, the respective piezo actuator is coupled to the respective actuating arm structure via a coupling joint, the respective actuating arm structure is divided into a first (e.g. pivotable) section and a second (e.g. axially movable) section by means of an intermediate joint and/or the respective actuating arm structure is, via a connecting joint, coupled, expediently directly or indirectly, to the rod, in particular at and/or by means of the bearing area.

At least one of the aforementioned joints can, e. g., be configured by a material weakening (e.g. a portion of reduced bending stiffness, in particular relative to two adjacent portions of higher bending stiffness, and/or a local reduction in cross-section), be one-piece integrally connected to the respective actuating arm structure, be configured as a solid-body joint, and/or be configured to be elastically deformable.

The base joint can preferably form a bearing point that allows, e.g., rotation of the respective actuating arm structure, but can preferably prevent all displacements. The base joint can thus form, e.g., a fixed bearing.

It is possible that the respective piezo actuator is preferably fixedly mounted in its transverse direction on one side and/or coupled on the other side (expediently indirectly or directly) to the respective actuating arm structure. Alternatively or additionally, the respective piezo actuator can, e.g., in its longitudinal direction, be, in particular bearing-free, deformable.

The respective piezo actuator can comprise, e.g., an elastically deformable, metallic and/or shell-shaped frame construction, wherein preferably the frame construction can be configured as, e.g., a bending stress frame and/or for reinforcing an actuating force on the respective actuating arm structure.

It is possible that at least one piezo active element (e.g. at least one piezo stack) is accommodated in the respective frame construction. The at least one piezo active element can be configured, e.g., from ceramic, in particular low-voltage ceramic.

The at least one piezo active element can act on the respective frame construction, in particular from the inside.

The at least one piezo active element preferably serves for longitudinally oriented deformation of the respective frame construction, e.g. to effect a particularly transversely oriented deformation of the respective frame construction for generating an actuating force for the respective actuating arm structure.

The at least one piezo active element can thus preferably act on the respective frame construction substantially in the longitudinal direction of the respective frame construction, e.g. to generate an (in particular transversely oriented) actuating force on the respective actuating arm structure.

It is possible that the respective frame construction is circumferential in its circumferential direction, in particular is closed.

The respective frame construction is preferably configured elongated, e.g. substantially elliptical to substantially rhomb-shaped and/or to substantially ring-shaped or circular-shaped.

It is possible that in the respective frame construction multiple piezo active elements (e.g. piezo stacks) are coupled in the longitudinal direction of the respective frame construction to each other and/or to the respective frame construction, e.g. for force and/or displacement increase.

In the transverse direction of the respective frame construction, e.g., a free space can be provided to allow the respective frame construction to change shape.

The respective piezo actuator can, preferably transversely (e.g. substantially perpendicularly) to its longitudinal extent, actuate the respective actuating arm structure. Alternatively or additionally, the respective frame construction can, preferably transversely (e.g. substantially perpendicularly) to its longitudinal extent, actuate the respective actuating arm structure.

The actuating arm structures are preferably arranged at an angle angularly to each other in order to act on the rod in different directions, in particular to act non-parallel and/or at an angle of unequal 0° and/or unequal 180° to the rod.

It is possible that the piezo actuator apparatuses, e.g. each in a plane (e.g. orthogonal to the system central axis and/or to the outlet of the nozzle), are aligned at an angle of unequal 0° and/or unequal 180° to each other. In particular, it is possible that the actuating arm structures, e.g. each in a plane (e.g. orthogonal to the system central axis and/or to the outlet of the nozzle), are aligned at an angle of unequal 0° and/or unequal 180° to each other.

The piezo actuator apparatuses, in particular their actuating arm structures, can, e.g., be configured to act on the rod at an angle of unequal 0° and/or unequal 180°, in particular to act on the rod non-parallel to each another.

The piezo actuator apparatuses are in particular configured to deflect, preferably variably deflect, the rod in different directions, which are non-parallel to each other, transversely (e.g. laterally, crosswise, obliquely and/or substantially orthogonally) to the longitudinal axis of the rod.

This can advantageously enable that the rod can be deflected in different (in particular non-parallel) directions.

It is possible that the piezo actuator apparatuses are preferably externally attached, e.g. mounted, on the applicator.

The piezo actuator device, preferably the applicator, can, e.g., be connected to a rotary feedthrough via which, e.g., the application agent can be supplied and/or returned.

It is possible that the piezo actuator device is connected to a heating device by means of which the application agent can be heated, which can be advantageous, e.g., in the case of highly viscous application agent, in particular adhesive. Alternatively or additionally, the piezo actuator device can, e.g., be connected to a cooling device (e.g. at least one Peltier element) by means of which the application agent can be cooled.

The heating device and/or the cooling device can, e.g., be installed on or in the applicator and/or, expediently in the flow direction of the application agent, positioned upstream of the application agent valve or downstream of the application agent valve.

The piezo actuator device, preferably the applicator, can, e.g., comprise at least one sensor for measuring a temperature of the application agent and/or comprise at least one sensor for measuring a pressure of the application agent.

The at least one sensor for measuring a temperature of the application agent and/or the at least one sensor for measuring a pressure of the application agent is positioned, expediently in the flow direction of the application agent, upstream of the application agent valve in order to preferably measure upstream of the application agent valve.

The piezo actuator device can comprise, e.g., an application agent supply (e.g. forerun) and an application agent return (e.g. runback) for application agent circulation or comprise at least two application agent supplies via which, e.g., different application agents can be supplied and preferably dispensed by means of the nozzle. The piezo actuator device can thus also be configured in particular for selectively dispensing different application agents.

The piezo actuator apparatuses can, e.g., be configured to deflect, depending on an (e.g. adjustable) excitation energy for their respective piezo actuator, the rod, expediently to different extends, in different directions transversely to its longitudinal axis. This enables that a respective stroke on the rod can be controlled in particular depending on the respective piezo actuator excitation energy.

The piezo actuator apparatuses can, in particular, be configured to exert a respective stroke on the rod, wherein the respective stroke is (expediently freely and/or arbitrarily) adjustable depending on an excitation energy for the respective piezo actuator, preferably to at least one intermediate position between a maximum stroke and a minimum stroke.

The excitation energy is in particular electrical excitation energy (expediently electrical voltage).

In the context of the disclosure, it is thus preferably possible to be able to (preferably freely and/or arbitrarily) adjust a respective stroke for transverse deflection of the rod as an application variable, which advantageously enables the generation of, e.g., different movement paths for the nozzle.

It is possible that an e.g. electronic control means is provided to control an excitation energy to be supplied to the respective piezo actuator apparatus and/or the respective piezo actuator.

It is possible that a generator means is provided for generating the excitation energy (e.g. electrical voltage, voltage signals, etc.) for the respective piezo actuator.

It is possible, e.g., that an amplification means is provided for amplifying the excitation energy generated by the generator means.

The generator means can, e.g., comprise one or multiple generators.

The amplification means can, expediently, comprise one or multiple amplifiers.

The control means can, e.g., be configured to control the generator means and/or the amplification means.

Therefore, the control means can control the excitation energy for the respective piezo actuator, e.g., via the generator means and/or the amplification means.

The respective piezo actuator is preferably controllable with (preferably electrical) excitation energy, in particular voltage, preferably voltage signals.

The control means can, in particular, be configured to control the excitation energy for the respective piezo actuator.

The control means is in particular an electronic control means and can comprise, e.g., at least one computing unit and/or at least one processor.

The control means can comprise, e.g., a memory unit in which a control software (e.g. a control program) and/or a control logic can be stored, according to which the excitation energy for the respective piezo actuator can be controlled.

It is possible within the scope of the disclosure, e.g., that the control means with its function is distributed to a central control unit or multiple different hardware components and/or control units.

The piezo actuators can be controlled, e.g., independently of each another, preferably by means of the control means.

The piezo actuators can, e.g., be applied with a same sized or differently sized actuating frequency and/or excitation energy.

The piezo actuator device preferably enables a defined application of the application agent on the component, which can, e.g., reduce or even completely eliminate rework. The defined application of the application agent can also advantageously reduce the consumption of application agent, which can, e.g., promote sustainable production.

The application agent is preferably viscous, in particular highly viscous.

In the context of the disclosure, the respective piezo actuator preferably serves for, in particular indirectly, moving and/or actuating the rod, preferably via the respective actuating arm structure.

The control means can, e.g., control the respective piezo actuator, e.g., indirectly or directly.

The excitation energy for the respective piezo actuator can be excitation energy amplified or non-amplified or reduced by means of the amplification means.

It should be mentioned that the piezo actuator apparatuses can be expediently configured to deflect, preferably variably deflect, the rod, in particular in different directions which are non-parallel to each other, transversely (e.g. laterally, crosswise, obliquely and/or substantially orthogonally) to the longitudinal axis of the rod.

The rod can, e.g., be configured in one part or multiple parts. Alternatively or additionally, the nozzle can, e.g., be configured in one part or multiple parts.

The nozzle can, e.g., be expediently directly or indirectly mounted to the rod, e.g. detachably or non-detachably. It is also possible, e.g., that the nozzle is configured as one-piece integral part of the rod.

The nozzle and the rod can preferably be arranged substantially coaxially to each other.

The piezo actuator device preferably servers for producing an application (e.g. an application agent seam, a coating and/or a swirl application, etc.) on the component.

The piezo actuator device can preferably be moved along the component by means of the manipulator during the dispensing of the application agent onto the component in order to produce an application (e.g. an application agent seam, a coating and/or a swirl application, etc.) on the component. However, embodiments are also possible in which the piezo actuator device is mounted, e.g., stationary.

It should be mentioned that the respective actuating arm structure, in particular the respective first section and/or second section, can be configured, e.g., at least partially elastically, in particular in order to be able to deform and/or bend elastically during actuation of the rod.

It should also be mentioned that in a non-deflected state and/or a basic or neutral position of the rod, the longitudinal axis of the rod and the system central axis can preferably be aligned substantially coaxially to each other.

It should further be mentioned that the piezo actuator device can comprise, e.g., at least three or at least four piezo actuator apparatuses and/or, e.g., at least three or at least four actuator arm structures.

It should be mentioned again that the rod can preferably be configured as a tube (e.g. nozzle tube), in particular with an axial inlet opening for the application agent and/or an axial outlet opening for the application agent. The rod can thus be, e.g., hollow, in particular an elongated hollow body.

The disclosure also includes an application device comprising at least one piezo actuator device as disclosed herein.

The application device can comprise, e.g., a single-axis or multi-axis (e.g. at least 2, at least 3, at least 4 or at least 5 axis) manipulator, in particular a robot for guiding the piezo actuator device. The manipulator serves in particular to move the piezo actuator device (in particular during an application of the application agent) along the component, whereby a superimposition of the nozzle movements, generated by the piezo actuator device, and the movements, generated by the manipulator, occurs in order, e.g., to be able to generate an application (e.g. an application agent seam, a coating and/or a swirl application, etc.) on the component.

However, it is also possible that the piezo actuator device is mounted stationary and is therefore, e.g., not mounted on a robot or manipulator.

The control means can also be used, e.g., to control the manipulator, in particular robot, disclosed herein. The control means can thus be, e.g., the manipulator control means, in particular the robot control means.

It is possible that a (e.g. camera- or laser-based) detection system (e.g. with one or multiple cameras and/or one or multiple lasers) is provided, e.g. in order to carry out a component measurement in particular timely preceding the application and/or in order to detect an application result (e.g. for carrying out a quality check, in particular an online quality check). The control means mentioned herein can, e.g., be configured to control the application depending on parameters detected by the detection system.

The disclosure also includes a method, in particular for a piezo actuator device and/or an application device as disclosed herein, so that the disclosure for the piezo actuator device and/or for the application device expediently also applies for the method.

In the method, a nozzle dispenses an application agent onto a component and at least two piezo actuator apparatuses deflect a rod (e.g. hollow and/or configured as a tube), that comprises the nozzle, in different directions transversely (e.g. laterally, crosswise, obliquely and/or substantially orthogonally) to the longitudinal axis of the rod.

The preferred embodiments of the disclosure described with reference to the figures partially correspond to each other, wherein similar or identical parts are provided with the same reference signs and reference can also be made to the description of the other embodiments for their explanation in order to avoid repetitions. For illustrative purposes, not all parts in all figures are provided with reference signs.

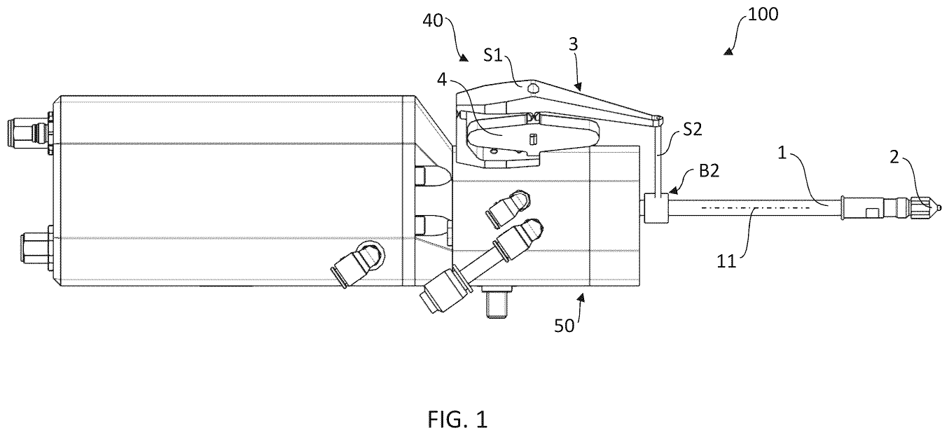

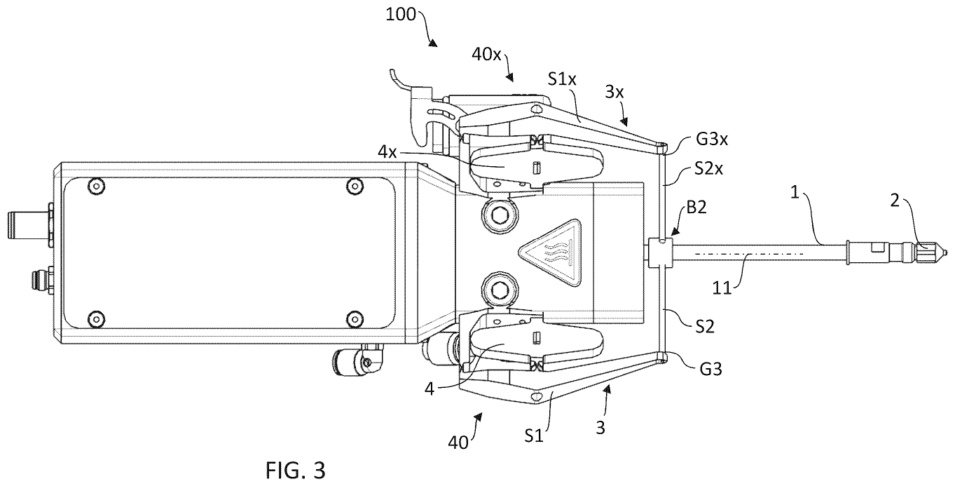

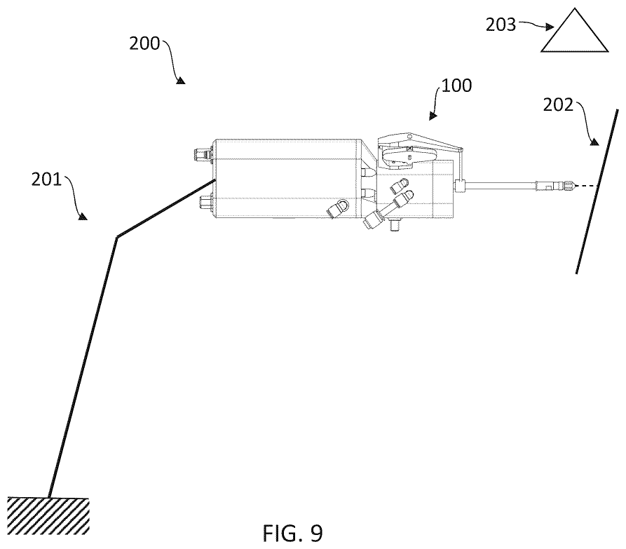

FIGS. 1 to 3 show different views of a piezo actuator device 100 according to an embodiment of the disclosure. The piezo actuator device 100 serves preferably for producing an application (e.g. an application agent seam, a coating, etc.) on a component 202 (e.g. a motor vehicle body component) shown schematically in FIG. 9, in particular for enabling a swirl application. The application agent can, e.g., be a viscous, in particular highly viscous application agent.

The piezo actuator device 100 comprises a nozzle 2 for dispensing an application agent onto the component 202, a rod 1, that comprises the nozzle 2, and at least two piezo actuator apparatuses 40, 40x. The piezo actuator apparatuses 40, 40x each comprise a piezo actuator 4, 4x and an actuating arm structure 3, 3x, which can be actuated, in particular driven, by the respective piezo actuator 4, 4x, for actuating, in particular driving, the rod 1.

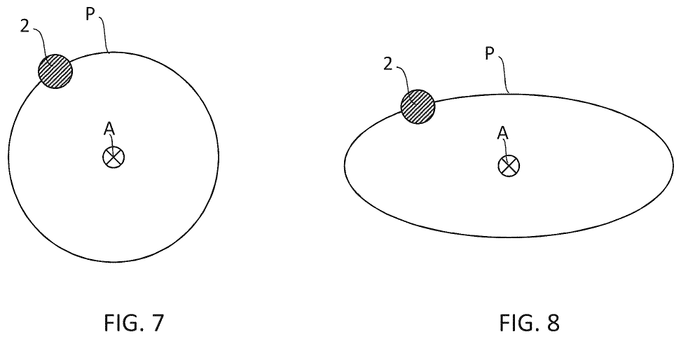

The piezo actuator apparatuses 40, 40x are configured to, in particular during dispensing of the application agent, preferably variably deflect the rod 1 transversely (e.g. laterally, crosswise, obliquely and/or substantially orthogonally) to its longitudinal axis 11 in different directions, which are in particular non-parallel to each other, preferably depending on an electrical excitation energy (e.g. electrical voltage) for the respective piezo actuator 4, 4x. By deflecting the rod 1, the nozzle 2 can be moved, e.g., along at least one movement path P, in particular around a system central axis A (e.g. FIGS. 7 and 8), wherein the at least one movement path P can include, e.g., at least one substantially circular movement path, at least one substantially elliptical movement path and/or at least one movement path deviating from a circular movement path.

A particular advantage is that the piezo actuator apparatuses 40, 40x can be configured to be able to adjust a respective stroke on the rod 1 expediently freely choosable, e.g. to at least one intermediate position between a maximum stroke and a minimum stroke. The respective stroke depends on the amount of excitation energy by means of which the respective piezo actuator 4, 4x is applied with.

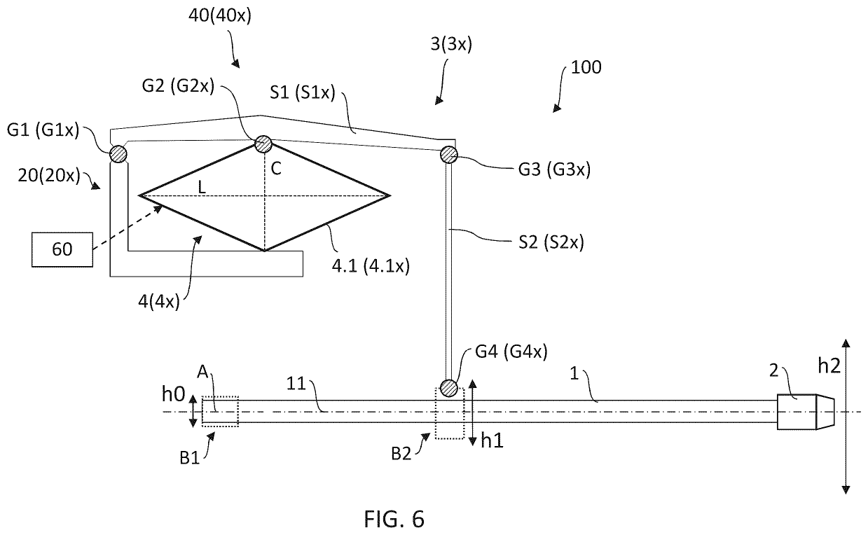

A control means 60 (e.g. FIG. 6) can be provided, which is configured to control the excitation energy. The control means 60 can comprise, e.g., a control unit, in particular with control software and/or control logic, by means of which the excitation energy for the respective piezo actuator 4, 4x and thus the excitation energy supplied to the respective piezo actuator 4, 4x can be controlled.

The piezo actuator apparatuses 40, 40x are preferably aligned to each other in a plane at an angle α of unequal 0° and/or unequal 180°, in particular in order to act on the rod 1 at an angle α of unequal 0° and/or unequal 180° and thus expediently non-parallel to each other.

A preferably variable deflection of the rod 1 by means of the piezo actuator apparatuses 40, 40x enables in particular that not only a single movement path can be generated, but that different movement paths P can be generated for the nozzle 2 (e.g. FIGS. 7 and 8). The one or the multiple movement paths P can include, e.g., at least one substantially circular movement path (e.g. FIG. 7) and/or at least one movement path deviating from a circular movement path, e.g. a substantially elliptical movement path (e.g. FIG. 8).

In the context of the disclosure, the nozzle 2 can be moved by means of the piezo actuator apparatuses 40, 40x preferably along different movement paths P. Alternatively or additionally, in the context of the disclosure, e.g. an application agent distribution in the cross-section of an application agent seam can be influenced by means of the piezo actuator apparatuses 40, 40x. This can advantageously achieve a substantially uniform application agent distribution in the cross-section of an application agent seam and/or reduce, preferably substantially avoid, an application agent edge accumulation in the cross-section of an application agent seam.

The piezo actuator apparatuses 40, 40x can be configured, e.g., to actuate the rod 1 with a preferably variable actuation frequency between, e.g., 0 Hz to at least 400 Hz and to move the nozzle 2 by means of the rod 1 at a rotational speed of, e.g., at least 10,000, at least 15,000 or at least 20,000 rotations per minute along a movement path P.

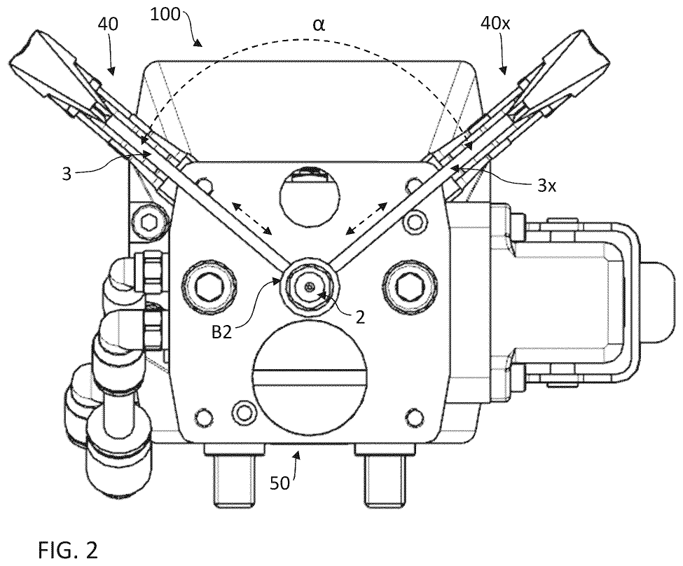

As already mentioned, the piezo actuator apparatuses 40, 40x each comprise a piezo actuator 4, 4x and an actuating arm structure 3, 3x, that can be actuated by the respective piezo actuator 4, 4x, for actuating the rod 1. In FIG. 2, the two dashed double arrows schematically indicate the actuating and driving direction of the respective actuating arm structure 3, 3x onto the rod 1.

The respective actuating arm structure 3, 3x can be divided, e.g., by means of an intermediate joint G3, G3x, into a first, preferably pivotable, section S1, S1x and a second, preferably axially movable, section S2, S2x, wherein the respective second section S2, S2x can be coupled to the rod 1 via a bearing area B2.

The piezo actuator device 100 also comprises an applicator 50, which can, e.g., comprise a valve block and to the outside of which the piezo actuator apparatuses 40, 40x can be attached.

The rod 1 is expediently supported in the bearing area B2 by means of the piezo actuator apparatuses 40, 40x and drivable transversely relative to its longitudinal axis 11. In particular, the respective second section S2, S2x can be expediently coupled to the bearing area B2 in order to drive the rod 1 transversely to its longitudinal axis 11. The bearing area B2 thus forms a drive point for in particular transversely driving the rod 1. The bearing area B2 can be positioned, e.g., outside the applicator 50.

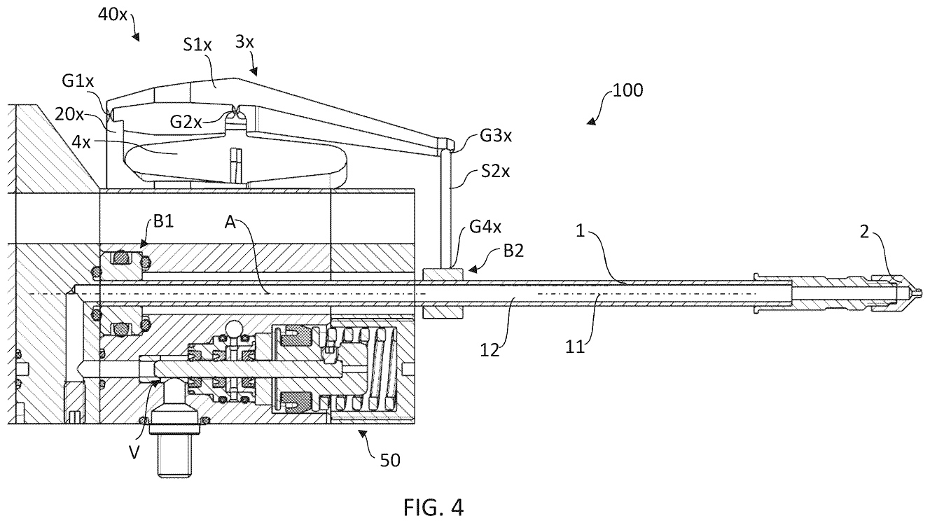

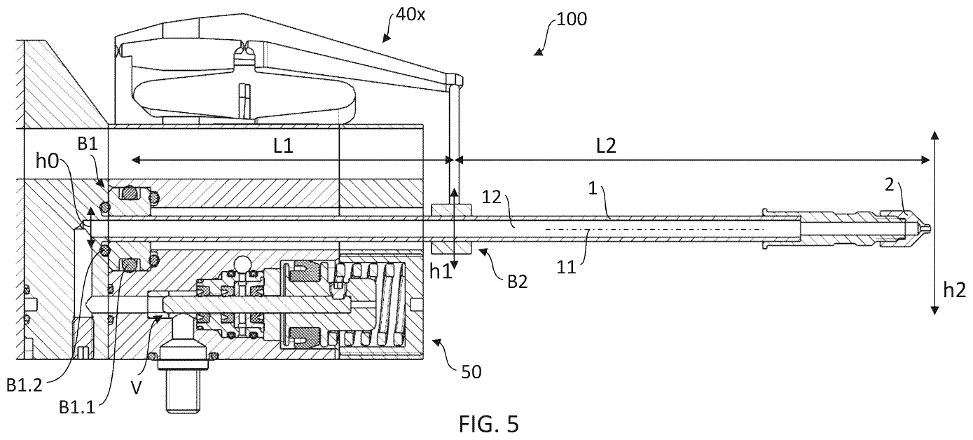

The piezo actuator device 100 is described further below with reference to FIGS. 4 to 6.

A bearing device B1 is configured to support the rod 1 in a wobbleable manner and/or to support the rod 1 transversely movable relative to its longitudinal axis 11. The bearing device B1 can, e.g., be supported expediently axially and/or radially by means of at least one elastic bearing element B1.1, B1.2, preferably by means of at least one expediently elastic O-ring. The bearing device B1 is preferably positioned in the applicator 50.

The bearing area B2 is positioned between the bearing device B1 and the nozzle 2.

A longitudinal extend L2 of the rod 1 from the bearing area B2 to the outlet of the nozzle 2 is preferably greater than a longitudinal extend L1 of the rod 1 from the bearing area B2 to the bearing device B1.

It follows from the leverage ratio of L1 to L2 that a deflection h2 of the nozzle 2 is greater than a deflection h1 of the rod 1 in the bearing area B2 and a deflection h0 of the rod 1 at the bearing device B1 is smaller than the deflection h1 in the bearing area B2 (e.g.: L2>L1 and/or h2>h1>h0).

Small bends, deformations and/or displacements (of e.g. only a few tenths of millimeters) can thus advantageously be sufficient to achieve a sufficiently large deflection h2 of the nozzle 2 (of e.g. at least 1 mm).

The respective actuating arm structure 3, 3x is preferably part of an at least three-joint or at least four-joint lever mechanism.

The respective actuating arm structure 3, 3x can, e.g., be pivotable about a base joint G1, G1x.

The respective piezo actuator 4; 4x can be expediently coupled to the respective actuating arm structure 3, 3x via a coupling joint G2, G2x, in particular to the respective first section S1, S1x.

The respective actuating arm structure 3, 3x can in particular be divided into the first section S1, S1x and the second section S2, S2x by means of an intermediate joint G3, G3x.

The respective actuating arm structure 3, 3x, in particular the respective second section S2, S2x, can be coupled to the rod 1 expediently in the bearing area B2 via a connecting joint G4, G4x.

It is possible that at least one of the aforementioned joints G1, G2, G3, G4; G1x, G2x, G3x, G4x is configured by a material weakening, is one-piece integrally connected to the respective actuating arm structure 3, 3x, is configured as a solid body joint, and/or is configured to be elastically deformable. Consequently, the bendings and/or deformations of the respective actuating arm structure 3, 3x and/or the respective joints G1, G2, G3, G4; G1x, G2x, G3x, G4x preferably take place in the elastic range.

The rod 1 is preferably configured as a hollow, expediently elongated tube and comprises an expediently central application agent channel 12 to guide the application agent to the nozzle 2. The application agent channel 12 can, e.g., extend through the bearing device B1 and/or through the bearing area B2 and comprise, e.g., an axial inlet opening for the application agent. In the context of the disclosure, the rod 1 thus also includes, in particular, a tube.

An application agent valve V, preferably comprising a valve needle, for activating and deactivating the dispensing of the application agent can be positioned in the applicator 50, wherein the application agent valve V can be positioned upstream of the rod 1 and/or can be positioned outside the rod 1. In particular, a valve seat for the valve needle can be positioned upstream of the rod 1 and/or outside the rod 1.

However, it is also possible that the piezo actuator device 100 comprises an application agent valve (not shown), comprising a valve needle, for activating and deactivating the dispensing of the application agent and the valve needle extends at least partially preferably axially in the rod 1 and/or in the nozzle 2. Here, the valve needle can, e.g., be configured to be bendable and/or extend through the bearing device B1 and/or the bearing area B2. A valve seat for the valve needle can, e.g., be positioned in the rod 1 and/or in the nozzle 2, preferably substantially directly before the nozzle 2. As a result, dripping of application agent can be reduced or avoided.

The respective piezo actuator 4, 4x preferably comprises an elastically deformable frame construction 4.1, 4.1x, wherein, e.g., the frame construction 4.1, 4.1x can be configured as a bending stress frame and/or for reinforcing an actuating force on the respective actuating arm structure 3, 3x.

The respective piezo actuator 4, 4.1 is preferably configured elongated with a longitudinal direction L and a transverse direction C.

The respective actuating arm structure 3, 3x is preferably a one-piece integral part of a frame 20, 20x (preferably open on at least one side), wherein the respective piezo actuator 4, 4x can be arranged, e.g., in the respective frame 20, 20x.

The respective piezo actuator 4, 4x can be mounted in its transverse direction C on one side on the respective frame 20, 20x and can be attached on the other side to the respective actuating arm structure 3, 3x by means of the respective coupling joint G2, G2x.

In its longitudinal direction L, however, the respective piezo actuator 4, 4x can be arranged, preferably bearing-free deformable, in the respective frame 20, 20x.

The respective frame construction 4.1, 4.1x and/or the respective piezo actuator 4, 4x can be configured at least slightly elongated and can, e.g., transversely to the longitudinal direction L, actuate the respective actuating arm structure 3, 3x, in particular substantially perpendicular to the longitudinal direction L. The respective frame construction 4.1, 4.1x is preferably configured circumferentially.

In the respective frame construction 4.1, 4.1x, e.g., one or multiple piezo active elements (e.g. one or multiple piezo stacks) for longitudinally oriented deformation of the respective frame construction 4.1, 4.1x are accommodated, wherein the longitudinally oriented deformation causes a transversely oriented deformation of the respective frame construction 4.1, 4.1x for generating the actuating force on the respective actuating arm structure 3, 3x.

In the respective frame construction 4.1, 4.1x, preferably multiple piezo active elements can be coupled in the longitudinal direction L of the respective frame construction 4.1, 4.1x to each other and to the respective frame construction 4.1, 4.1x, wherein, e.g., a free space can be provided in the transverse direction C of the respective frame construction 4.1, 4.1x.

The at least one movement path P, that can be generated by means of the piezo actuator apparatuses 40, 40x, preferably extends around a system central axis A of the piezo actuator device 100. The system central axis A can, e.g., extend centrally through the bearing device B1 and/or be defined by a center axis of the bearing device B1.

FIGS. 4 to 6 show the rod 1 in a non-deflected state, in particular in a basic or neutral position. Here, the system central axis A is expediently aligned substantially coaxially with the longitudinal axis 11 of the rod 1.

FIGS. 7 and 8 illustrate exemplary different movement paths P of the nozzle 2 expediently around the system central axis A. The movement paths P can be generated and modeled by means of the piezo actuator apparatuses 40, 40x, in particular depending on the excitation energy for their respective piezo actuator 4, 4x. The at least one movement path P can, e.g., extend eccentrically to the system central axis A and/or represent an (e.g. open or closed) circulating path around the system central axis A.

An advantage is in particular that by means of the piezo actuator apparatuses 40, 40x, e.g., at least one circular movement path P for the nozzle 2 (FIG. 7), at least one elliptical movement path P for the nozzle 2 (FIG. 8) and/or at least one movement path, that deviates from a circular movement path (FIG. 8), can be generated.

FIG. 9 shows an application device 200, with a piezo actuator device 100 and a manipulator 201, shown only schematically, for guiding the piezo actuator device 100, and a component 202, shown only schematically. The manipulator 201 can be, e.g., a robot with at least 2, at least 3, at least 4 or at least 5 axes of movement.

The manipulator 201 serves in particular to move the piezo actuator device 100 (in particular during an application of the application agent) along the component 202 (e.g. a motor vehicle body component), whereby a superimposition of the nozzle movements, generated by means of the piezo actuator device 100, and the movements, generated by the manipulator 201, takes place in order to be able to generate an application, in particular a swirl application, on the component 202.

The application device 200 can comprise, e.g., a vision system 203, which is only shown schematically, in particular a (e.g. camera-or laser-based) detection system (e.g. with one or multiple cameras and/or one or multiple lasers), e.g. to carry out a component measurement in particular timely preceding the application and/or in order to detect an application result (e.g. for carrying out a quality check, in particular an online quality check). The control means 60 can, e.g., be configured to control the application depending on parameters detected by the detection system.

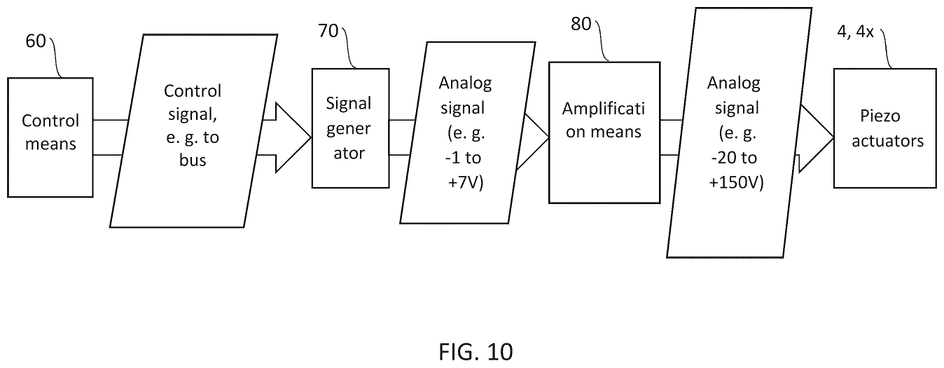

FIG. 10 shows a control scheme, in particular a signal processing scheme for a piezo actuator device 100 according to an embodiment of the disclosure.

A control means 60 is provided by means of which the excitation energy (e.g. electrical voltage) for the respective piezo actuator 4, 4x and thus the excitation energy supplied to the respective piezo actuator 4, 4x can be controlled (e.g. via a generator means 70 and an optional amplification means 80), preferably in order to control the transverse deflection of the rod 1.

The generator means 70 serves to generate the excitation energy for the respective piezo actuator 4, 4x, in particular to generate (e.g. substantially rectangular and/or pre-shaped) voltage signals (e.g. −1 V to +7 V) for the respective piezo actuator 4, 4x. For example, own voltage signals can advantageously be generated per piezo actuator 4, 4x.

The control means 60 serves in particular to control the generator means 70 and/or the amplification means 80.

The optional amplification means 80 serves to amplify the excitation energy generated by the generator means 70.

The optionally amplified excitation energy and thus the voltage signals can be supplied to the respective piezo actuator 4, 4x. The voltage signals are, e.g., substantially rectangle voltage signals.

The respective piezo actuator 4, 4x can, depending on the excitation energy, act on the rod 1 via the respective actuating arm structure 3, 3x.

The shape of the respective stroke curve can, in principle, substantially correspond to the curve of the voltage signals generated by the generator means 70.

However, it is possible, e.g., that the excitation energy and thus the voltage signals are pre-shaped (expediently “preshaping” of the voltage signals), e.g. in order to prevent the rod 1 from overswinging (e.g. in the case of fast control).

1.-32. (canceled)

33. A piezo actuator device attachable to a manipulator to enable a swirl application on a component, comprising:
a nozzle for dispensing an application agent onto the component,
a hollow rod, and
at least two piezo actuators configured to deflect the rod in different directions transversely to its longitudinal axis, whereby the nozzle is movable along at least one movement path.

34. The piezo actuator device according to claim 33, wherein the piezo actuators are configured to variably deflect the rod in different directions transversely to its longitudinal axis, preferably whereby the nozzle is movable along different movement paths.

35. The piezo actuator device according to claim 33, wherein the at least one movement path comprise at least one substantially circular movement path, at least one substantially elliptical movement path and/or at least one movement path deviating from a circular movement path.

36. The piezo actuator device according to claim 33, wherein the piezo actuator comprises a bearing device which is configured to support the rod in a wobbleable manner and is supported by at least one elastic bearing element.

37. The piezo actuator device according to claim 33, wherein the rod is drivable in a bearing area transversely relative to its longitudinal axis.

38. The piezo actuator device according to claim 37, wherein the bearing area is positioned between the bearing device and the nozzle.

39. The piezo actuator device according to claim 33, wherein the piezo actuators are configured
to actuate the rod with a, preferably variable, actuating frequency between 0 Hz to at least 300 Hz, to at least 350 Hz or to at least 400 Hz, and
to move the nozzle by means of the rod on at least one movement path, preferably a circular path, which corresponds to a rotational speed of at least 10,000, at least 15,000 or at least 20,000 revolutions per minute.

40. The piezo actuator device according to claim 33, wherein the rod comprises an application agent channel to guide the application agent to the nozzle.

41. The piezo actuator device according to claim 40, wherein the application agent channel extends through the bearing device and/or the bearing area and/or comprises an axial inlet opening for the application agent.

42. The piezo actuator device according to claim 33, wherein the piezo actuator device comprises an applicator, wherein
the bearing device is positioned in the applicator,
the bearing area is positioned outside the applicator, and
the application agent can be guided through the applicator into the rod and/or the nozzle.

43. The piezo actuator device according to claim 33, wherein the piezo actuator device comprises an application agent valve including a valve needle, for activating and deactivating the dispensing of the application agent and a valve seat, is positioned upstream of the rod and outside the rod.

44. The piezo actuator device according to claim 33, wherein the piezo actuator device comprises an application agent valve, comprising a flexible valve needle, and the valve needle extends axially in the rod and in the nozzle.

45. The piezo actuator device according to claim 33, wherein the piezo actuator apparatuses each comprise a piezo actuator and an actuating arm structure, that can be actuated by the respective piezo actuator, for actuating the rod.

46. The piezo actuator device according to claim 45, wherein the respective actuating arm structure is part of an at least three-joint lever mechanism.

47. The piezo actuator device according to claim 45, wherein
the respective actuating arm structure is pivotable about a base joint.

48. The piezo actuator device according to claim 47, wherein at least one of the joints is configured to be elastically deformable.

49. The piezo actuator device according to claim 45 wherein the respective piezo actuator comprises an elastically deformable frame construction, wherein the respective frame construction is configured as a bending stress frame.

50. The piezo actuator device according claim 33, wherein
the piezo actuator apparatuses are aligned non-parallel to each other.

51. The piezo actuator device according to claim 42 wherein the piezo actuator apparatuses are attached to the applicator.

52. The piezo actuator device according to claim 33 wherein the piezo actuator device, in particular the applicator, is connected to a rotary feedthrough via which the application agent can be supplied and/or returned.

53. The piezo actuator device according to claim 33, wherein the piezo actuator device
is connected to a heating device which heats the application agent.

54. The piezo actuator device according to claim 33, wherein the piezo actuator device is connected to a cooling device which cools the application agent.

55. The piezo actuator device according to claim 33, wherein the piezo actuator device is connected to an application agent supply and an application agent return for application agent circulation.

56. The piezo actuator device according to claim 33, wherein the piezo actuator apparatuses are configured to deflect, based on an excitation energy applied to each piezo actuator, the rod to different extends in different directions transversely to its longitudinal axis.

57. The piezo actuator device according to claim 33, wherein the piezo actuator apparatuses are configured to exert a respective stroke on the rod, wherein the respective stroke is adjustable depending on an excitation energy for the respective piezo actuator.

58. The piezo actuator device according to claim 33, wherein a controller is provided to control an excitation energy to be supplied to the respective piezo actuator device.

59. The piezo actuator device according to claim 33, wherein a transverse deflection of the nozzle is greater than a deflection of the rod in the bearing area and a deflection of the rod at the bearing device is smaller than the deflection in the bearing area.

60. The piezo actuator device according to claim 33, wherein the piezo actuator device further comprises at least one of a sensor for measuring a temperature of the application agent or a sensor for measuring a pressure of the application agent.

61. The piezo actuator device according to claim 60, wherein the at least one sensor for measuring a temperature of the application agent and/or the at least one sensor for measuring a pressure of the application agent is positioned upstream of the application agent valve.
